(19) United States
(12) Patent Application Publication
(10) Pub. No.: US 2004/0220828 A1
(43) Pub. Date: Nov. 4, 2004

(54) Trade indication data transmission method and system, and reception apparatus

(76) Inventor: Osamu Yamazaki, Osaka (JP)

Correspondence Address: McDERMOTT, WILL & EMERY, 600 13th Street, N.W., Washington, DC, 20005-3096, US

(21) Appl. No.: 10/854,147

(22) Filed: May 27, 2004

Related U.S. Application Data
(63) Continuation-in-part of application No. PCT/JP02/07792, filed on Jul. 31, 2002.

(51) Int. Cl. G06F 17/60

(52) U.S. Cl. 705/1

(57) ABSTRACT

Trade indication data in which a characteristic to identify a receiver is inserted is transmitted. By this, when the transmitted trade indication data is falsely used, the origin of the trade indication data can be identified, and therefore, the trade indication can be appropriately protected. Here, the characteristic may be modified for each lot, or the characteristic may be inserted in a pattern of the trade indication and can be recognized from the appearance of the trade indication. The characteristic may be an electronic watermark, or may include information related to a limitation on the number of copying.

### CROSS REFERENCE TO THE RELATED APPLICATION

This application is based on and claims the benefit of PCT application JP2002/007792 filed on Jul. 31, 2002, the contents of which is incorporated herein by reference in its entirety.

### TECHNICAL FIELD

The present invention relates to trade indication data used for indicating trade indication, a recording medium recording the trade indication data, a trade indication data transmission method, a trade indication data transmission server, a trade indication data reception apparatus and a trade indication data transmission system.

### BACKGROUND ART

The trade indication is hereby defined as an indication of origin or association, for example, the trade indication can be a name related to business of a person, a trade name, a trademark, a service mark, a collective mark, a certification mark, an emblem, a configuration of a container or packaging of commodity, trade dress, and others, and as often typified by a trademark. A trade mark is an important intellectual property having an origin indication function, a quality guarantee function, and/or an advertising function. Accordingly, owners and authorized persons of the trade indication have taken various measures against unauthorized users of the trade indication in order to keep and maintain the intellectual property provided by the trade indication, such as an authorized persons good will and reputation of quality and trustworthiness. However, wrongful or unauthorized use of trade indication is still made in various places. This continued unauthorized use of the trade indication causes a great deal of damage to consumers, who are often tricked into buying inferior products or services, and to the authorized persons whose good will and reputation suffers. Moreover, as business activity becomes increasingly global, unauthorized use of trade indications is rapidly expanding worldwide.

Conventionally, in the case where other companies are allowed to use a trade indication of a certain company, all of the same information of the trade indication is delivered to each of the several companies who are then allowed to use it. When a company which has received this information falsely delivers this information to a third company, the third company may wrongfully use this information to attach the trade indication to its own illegal product. Also, a company which has legally received the information of the trade indication may wrongfully use the information of the trade indication on an inappropriate or unauthorized product, or may wrongfully distribute the information to an unauthorized third party.

However, according to the foregoing method, since the same information of the trade indication is delivered irrespective of users who are to receive the information of the trade indication and to use it, there is a problem that in the case where the information of the trade indication is wrongfully used, it is difficult to identify the origin of the information of the trade indication which was wrongfully used, and the trade indication cannot be appropriately protected.

### SUMMARY OF THE INVENTION

The present invention is made in view of the above, and has an object to appropriately protect trade indication.

Trade indication data of the present invention is data of trade indication, and a characteristic to identify a user to use the data is inserted therein. By this, in the case where the transmitted trade indication data is falsely used, the origin of the trade indication data can be identified. A recording medium of the invention readable by an information processing apparatus records the foregoing trade indication data. Here, the information processing apparatus includes, in addition to a general computer terminal, all electronic equipments having a function to read the trade indication data from the recording medium, and also includes a disk drive or the like incorporated in a printer. The recording medium includes a portable recording medium, for example, a magnetic disk such as a floppy disk, a semiconductor memory (including one incorporated in a cartridge, a PC card or the like) such as ROM, EPROM, EEPROM or flash ROM, an optical disk such as CD-ROM or DVD, and a magneto-optical disk such as MO, and a stationary recording medium such as ROM, RAM or hard disk.

A trade indication data transmission method of this invention transmits trade indication data in which a characteristic to identify a reception apparatus to receive the trade indication data and/or a user to use the received trade indication data is inserted. By this method, when the transmitted trade indication data is falsely used, the origin of the trade indication data can be identified. A trade indication data transmission method of the invention includes an authentication step of authenticating a reception apparatus to receive trade indication data and/or a user to use the received trade indication data, and a transmission step of transmitting the trade indication data in which a characteristic corresponding to the reception apparatus and/or the user authenticated at the authentication step is inserted to the transmission destination. By this method, when the transmitted trade indication data is falsely used, the origin of the trade indication data can be identified.

Here, the characteristic may be modified for each lot. By this, the lot can be identified. The characteristic may be inserted in a pattern of the trade indication and it can be recognized from appearance of the trade indication. By this, the characteristic is recognized from the displayed trade indication and the origin of the trade indication data can be identified. The characteristic may be an electronic watermark. The characteristic may include information related to a limitation on the number of making a copy. By this, the number of copying can be restricted by using this information.

A trade indication data transmission server of this invention transmits trade indication data in which a characteristic to identify a reception apparatus to receive the trade indication data and/or a user to use the received trade indication data is inserted. By this, when the transmitted trade indication data is falsely used, the origin of the trade indication data can be identified. A trade indication data transmission server of the invention includes an authentication unit for authenticating a reception apparatus to receive trade indication data and/or a user to use the received trade indication data, and a transmission unit for transmitting the trade indication data in which a characteristic corresponding to the reception apparatus and/or the user authenticated by the authentication unit is inserted to the transmission destination. By this, when the transmitted trade indication data is falsely used, the origin of the trade indication data can be identified.

A trade indication data reception apparatus of this invention includes an authentication unit for performing an authentication processing in cooperation with a trade indication data transmission server for transmitting trade indication data, and a reception unit for receiving the trade indication data in which a characteristic corresponding to its own apparatus and/or a user to use the received trade indication data is inserted, from the trade indication data transmission server.

A trade indication data transmission system of this invention includes a trade indication data transmission server for transmitting trade indication data, and plural trade indication data reception apparatuses for receiving the trade indication data, the trade indication data transmission server includes a server side authentication unit for authenticating the trade indication data reception apparatus and/or a user to use the received trade indication data, and a transmission unit for transmitting the trade indication data in which a characteristic corresponding to the trade indication data reception apparatus and/or the user authenticated by the server side authentication unit is inserted to the trade indication data reception apparatus, and the trade indication data reception apparatus includes a reception side authentication unit for performing an authentication processing in cooperation with the trade indication data transmission server, and a reception unit for receiving the trade indication data in which the characteristic corresponding to its own apparatus and/or the user is inserted, from the trade indication data transmission server.

### BRIEF DESCRIPTION OF THE DRAWINGS

The accompanying drawings, which are incorporated in and form a part of the specification, illustrate various embodiments of the present invention and, together with the description, serve to explain the principles of the invention. In the drawings:

FIG. 1 is a block diagram showing a rough structure of a trade indication data transmission system according to a first exemplary embodiment of the present invention;

FIG. 2 is a block diagram showing a rough structure of a trade indication data transmission server shown in FIG. 1;

FIG. 3 is a block diagram showing a rough structure of a trade indication data reception apparatus shown in FIG. 1;

FIGS. 4A-4E are explanatory views showing insertion methods of characteristics according to the first exemplary embodiment;

FIG. 5 is a flowchart showing a procedure of a trade indication data transmission processing according to the first exemplary embodiment;

FIG. 6 is a flowchart showing a procedure of a trade indication data reception processing according to the first exemplary embodiment;

FIG. 7 is a block diagram showing a rough structure of a trade indication data transmission server according to a second exemplary embodiment of the present invention;

FIG. 8 is a block diagram showing a rough structure of a trade indication data creation part shown in FIG. 7;

FIG. 9 is a block diagram showing a rough structure of a trade indication data reception apparatus according to the second exemplary embodiment;

FIG. 10 is a flowchart showing a procedure of a trade indication data transmission processing according to the second exemplary embodiment;

FIG. 11 is a flowchart showing a procedure of a trade indication data creation processing according to the second exemplary embodiment; and

FIG. 12 is a flowchart showing a procedure of a trade indication data reception processing according to the second exemplary embodiment.

### DETAILED DESCRIPTION OF PREFERRED EMBODIMENTS

Hereinafter, embodiments of this invention will be described in detail with reference to the accompanying drawings. This invention is not limited to the embodiments.

### Exemplary Embodiment 1

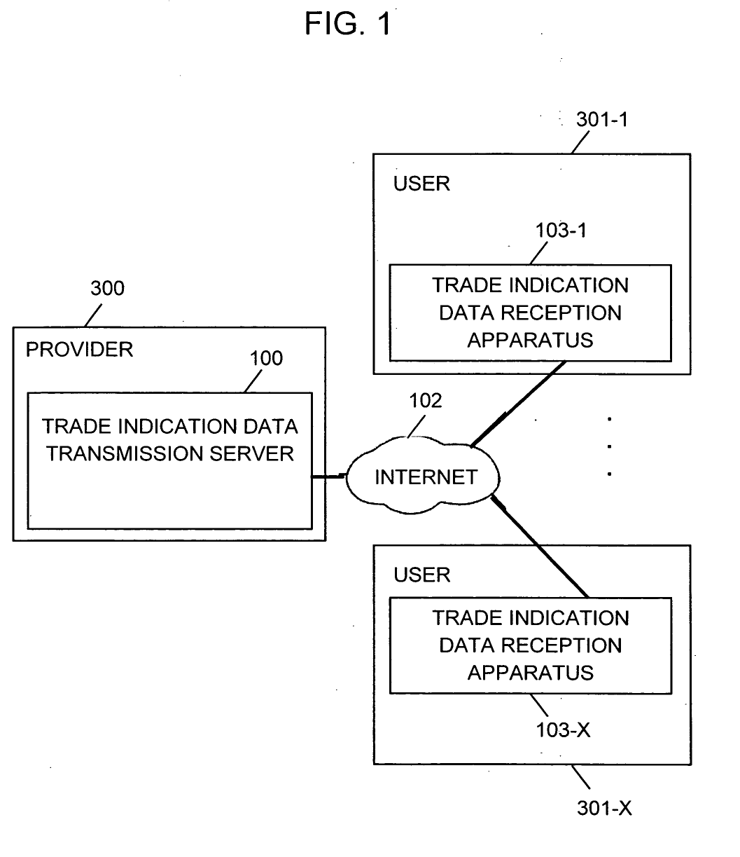

FIG. 1 is a block diagram showing a rough structure of a trade indication data transmission system according to a first exemplary embodiment of the present invention. This trade indication data transmission system includes at least one trade indication data transmission server 100, and plural trade indication data reception apparatuses 103-1 to 103-X (X is an arbitrary integer). Trade indication data transmission server 100 transmits trade indication data, in which characteristics to identify trade indication data reception apparatuses 103-1 to 103-X are inserted, to trade indication data reception apparatuses 103-1 to 103-X via Internet 102. Trade indication data reception apparatuses 103-1 to 103-X receive the trade indication data from trade indication data transmission server 100.

The trade indication data may be, for example, image data of trade indication. Trade indication data transmission server 100 is, for example, a server used by provider 300, such as a parent company managing the trade indication, and trade indication reception apparatuses 103-1 to 103-X are, for example, computer apparatuses used by users 301-1 to 301-X to use the received trade indication data, such as subsidiary companies, related companies, customers and the like allowed to use the trade indication by their parent companies.

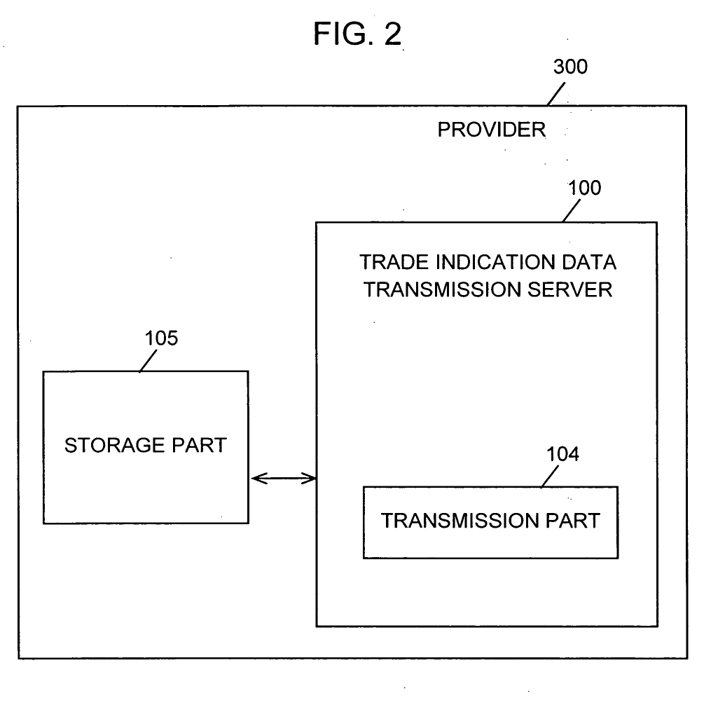

FIG. 2 is a block diagram showing a rough structure of trade indication data transmission server 100 shown in FIG. 1. Trade indication data transmission server 100 is connected to storage part 105. Trade indication data transmission server 100 includes transmission part 104. Storage part 105 stores the trade indication data in which the characteristics to identify users 301-1 to 301-X and/or trade indication data reception apparatuses 103-1 to 103-X are inserted.

Transmission part 104 reads the trade indication data from storage part 105 and transmits it to trade indication data reception apparatuses 103-1 to 103-X. Respective trade indication data reception apparatuses 103-1 to 103-X and/or users 301-1 to 301-X and the respective trade indication data may be made to previously correspond to each other, or may be made to correspond to each other when they are transmitted. In either case, the correspondence between the trade indication data in which the characteristics are inserted and the trade indication data reception apparatuses and/or users 301-1 to 301-X is stored in storage part 105. The characteristics which may vary for each lot of products may be added to the trade indication data and the trade indication data to be transmitted may be switched for each lot.

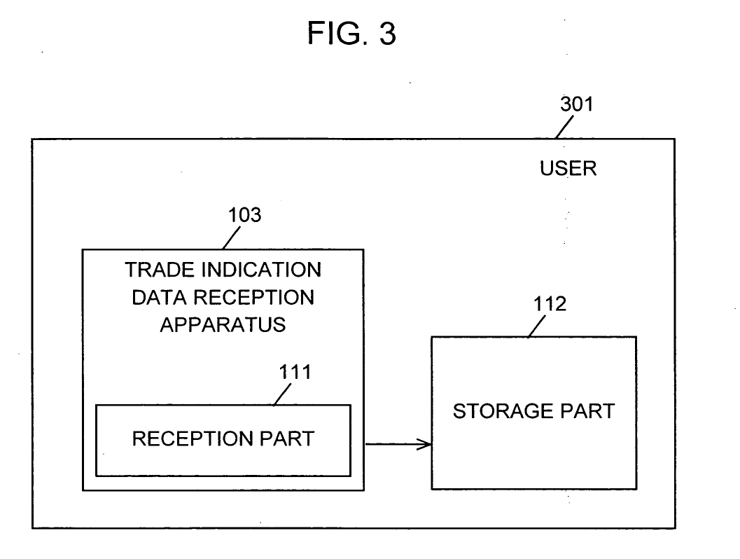

All of trade indication data reception apparatuses 103-1 to 103-X include the same structure. Hereinafter, trade indication data reception apparatuses 103-1 to 103-X will be collectively referred to as trade indication data reception apparatus 103. Likewise, users 301-1 to 301-X will be collectively referred to as user 301. FIG. 3 is a block diagram showing a rough structure of trade indication data reception apparatus 103. Trade indication data reception apparatus 103 is connected to storage part 112. Trade indication data reception apparatus 103 includes reception part 111. Reception part 111 receives the trade indication data from trade indication data transmission server 100 and stores it in storage part 112.

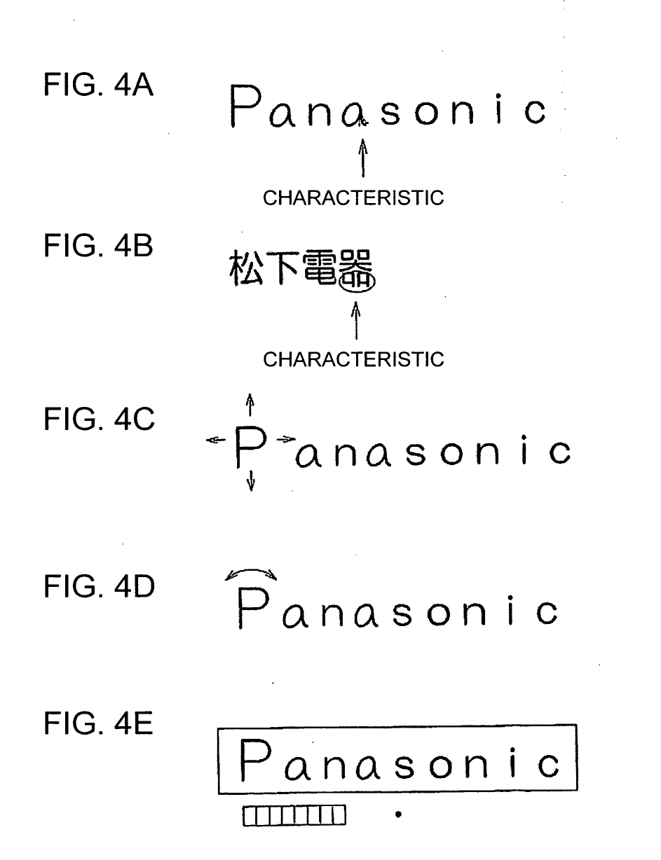

FIGS. 4A-4E are explanatory views showing insertion methods of characteristics according to the first exemplary embodiment. This characteristic insertion is performed by, for example, applying minute modifications to a pattern of trade indication. This minute modification is like a noise and is performed so that the modified trade indication is regarded as the same as or similar to the trade indication. This characteristic can be recognized when the trade indication is displayed. The characteristic inserted in the trade indication data may be a change in an angle of a “swept line” of a character as shown in FIG. 4A, it may be a change in the “penetration” of a character as shown in FIG. 4B, it may be a shift of a part of the trade indication horizontally or vertically as shown in FIG. 4C, or it may be a rotation of a part of the trade indication as shown in FIG. 4D.

The characteristic inserted in the trade indication data may be addition of an additive such as a bar code, a dot or a frame as shown in FIG. 4E, or a change in base design, pattern, color arrangement or the like. Further, the characteristic inserted in the trade indication data may be a change in color, use of or a change in a hologram, use of or a change in a three-dimensional view. As stated above, plural trade indication data slightly different from one another are stored in the storage part 105.

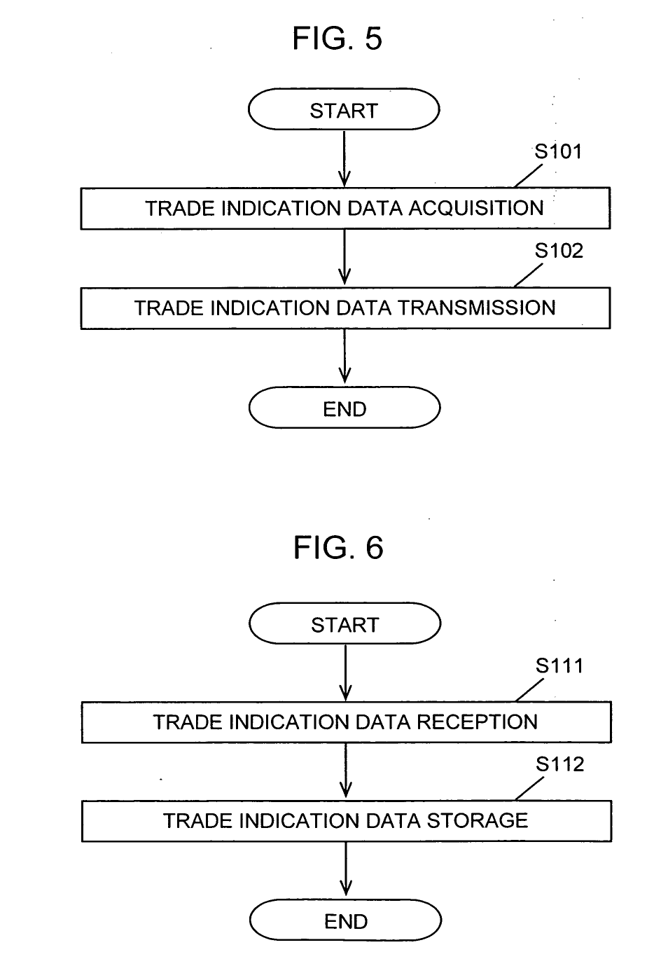

In the above structure, the operation of the first exemplary embodiment will be described with reference to flowcharts of FIGS. 5 and 6. For example, when a parent company allows a customer (or a subsidiary company, a related company, etc.) to use the trade indication, after allowing the customer to use the trade indication, the parent company issues a specified trade indication. A trade indication data transmission processing performed at this time starts when trade indication data reception apparatus 103 accesses trade indication data transmission server 100 and a transmission request for the trade indication data is made, or it may start when trade indication data transmission server 100 accesses trade indication data reception apparatus 103.

FIG. 5 is a flowchart showing a procedure of the trade indication data transmission processing according to the first exemplary embodiment. In the trade indication data transmission processing, first, transmission part 104 acquires the trade indication data in which the characteristic to identify trade indication data reception apparatus 103 and/or user 301 is inserted, from storage part 105 (S101). Transmission part 104 transmits the acquired trade indication data to trade indication data reception apparatus 103 (S102).

FIG. 6 is a flowchart showing a procedure of trade indication data reception processing according to the first exemplary embodiment. In this trade indication data reception processing, first, reception part 111 receives the trade indication data transmitted by the trade indication data transmission processing (S111). Reception part 111 stores the received trade indication data into storage part 112 (S112). When trade indication data reception apparatus 103 falsely delivers this trade indication data to a third party, and the third party falsely uses this trade indication data, or trade indication data reception apparatus 103 itself falsely uses the trade indication data, the characteristic is extracted from the appearance of the trade indication, and trade indication data reception apparatus 103 and/or user 301 corresponding to the characteristic is identified, so that the origin of the falsely used trade indication data can be identified.

As described above, according to the first exemplary embodiment, since the trade indication data in which the characteristic to identify trade indication data reception apparatus 103 and/or user 301 is inserted is transmitted, when the transmitted trade indication data is falsely used, the origin of the trade indication data can be identified, and therefore, the trade indication can be appropriately protected.

### Exemplary Embodiment 2

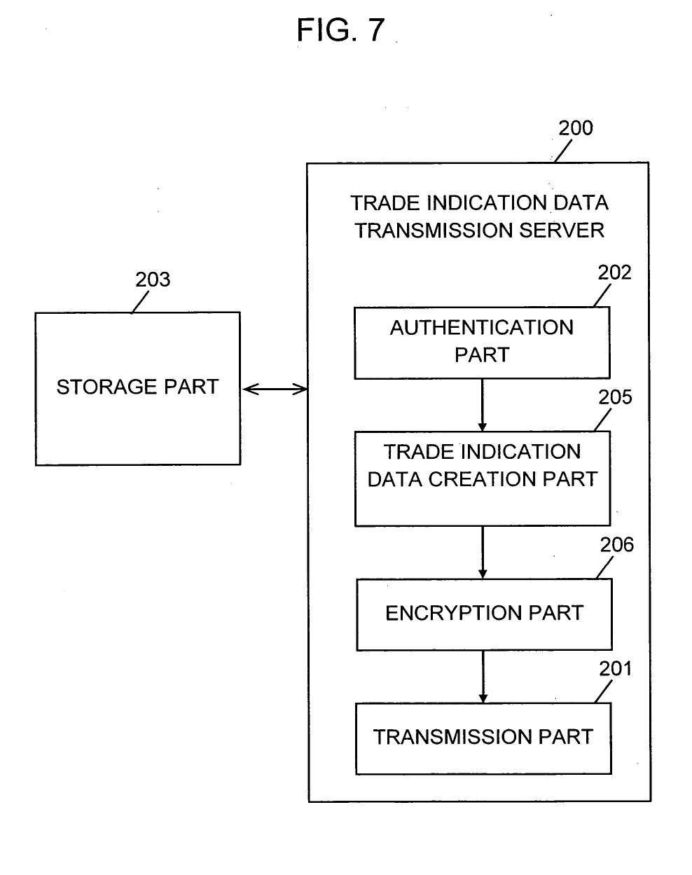

In a trade indication data transmission system according to a second exemplary embodiment of the present invention, similarly to the trade indication data transmission system of the first exemplary embodiment shown in FIG. 1, at least one trade indication data transmission server and plural trade indication data reception apparatuses are connected to Internet 102. Similarly to the first exemplary embodiment, a provider uses the trade indication data transmission server to send trade indication data, and a user uses the trade indication data reception apparatus to receive the trade indication data and uses it. FIG. 7 is a block diagram showing a rough structure of the trade indication data transmission server according to the second exemplary embodiment. Trade indication data transmission server 200 of the second exemplary embodiment is connected to storage part 203. Besides, trade indication data transmission server 200 includes transmission part 201, authentication part 202, trade indication data creation part 205, and encryption part 206.

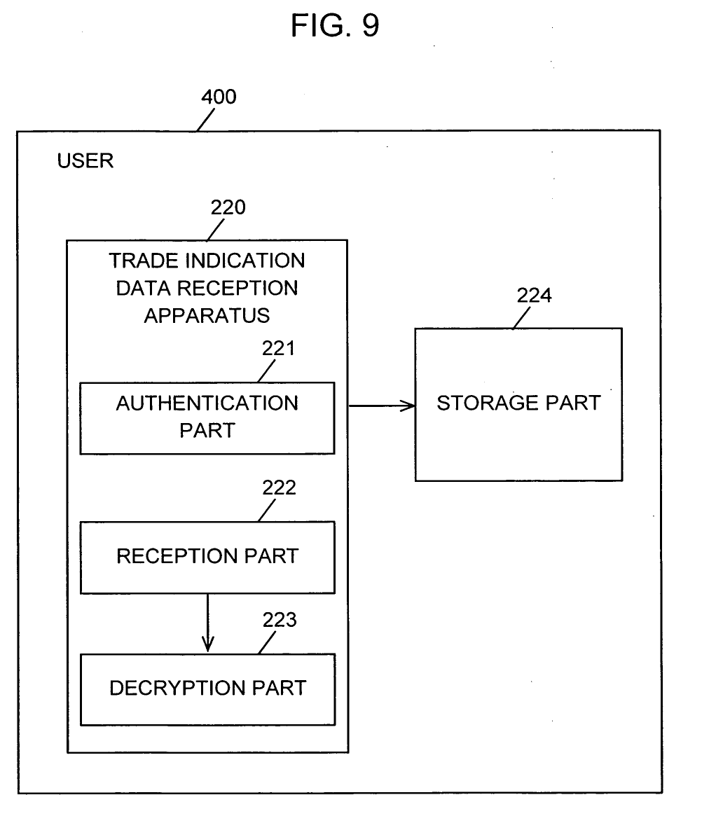

Authentication part 202 authenticates after-mentioned trade indication data reception apparatus 220 (FIG. 9) and/or user 400 (FIG. 9) to use trade indication data reception apparatus 220. A method of authentication is not specifically limited. For example, a specific password may be inputted from trade indication data reception apparatus 220, a secret key and a public key may be used, a common key may be used, or an ID intrinsic to trade indication data reception apparatus 220 may be automatically transmitted. Trade indication data transmission server 200 and/or user 400 and trade indication data reception apparatus 220 may perform mutual authentication. By this, since trade indication data transmission server 200 and/or user 400, and trade indication data reception apparatus 220 mutually confirm that they are authorized to can deliver the trade indication data, appropriate protection of the trade indication can be performed.

Trade indication data creation part 205 creates the trade indication data in which an electronic watermark for identifying trade indication data reception apparatus 220 and/or user 400 is inserted. The kind of the electronic watermark is not specifically limited. For example, a statistical property of an image may be used, or a frequency space such as Fourier transformation, spectrum diffusion or DCT may be used. Further, an electronic watermark key may be used to insert an electronic watermark, and information of the electronic watermark cannot be read if data reception apparatus does not have the electronic watermark key. The electronic watermark may be such that it can be recognized when the trade indication is displayed, or may be recognized by analyzing the trade indication data.

Encryption part 206 encrypts at least the portion of the trade indication data in which the electronic watermark to identify trade indication data reception apparatus 220 and/or user 400 is inserted. A method of encryption is not particularly limited. The secret key or the public key may be used, the common key may be used, and/or the DES, RSA, IDEA or the like may be used.

Storage part 203 stores plural encryption keys corresponding to respective trade indication data reception apparatuses 220 and/or respective users 400, and encryption part 206 reads the encryption key corresponding to trade indication data reception apparatus 220 from storage part 203, and encrypts the trade indication data by using the read encryption key. Transmission part 201 transmits the trade indication data encrypted by encryption part 206 to trade indication data reception apparatus 220 via Internet 102. Storage part 203 stores at least one piece of trade indication data, and stores data for authentication, data for trade indication data creation, data for encryption and the like.

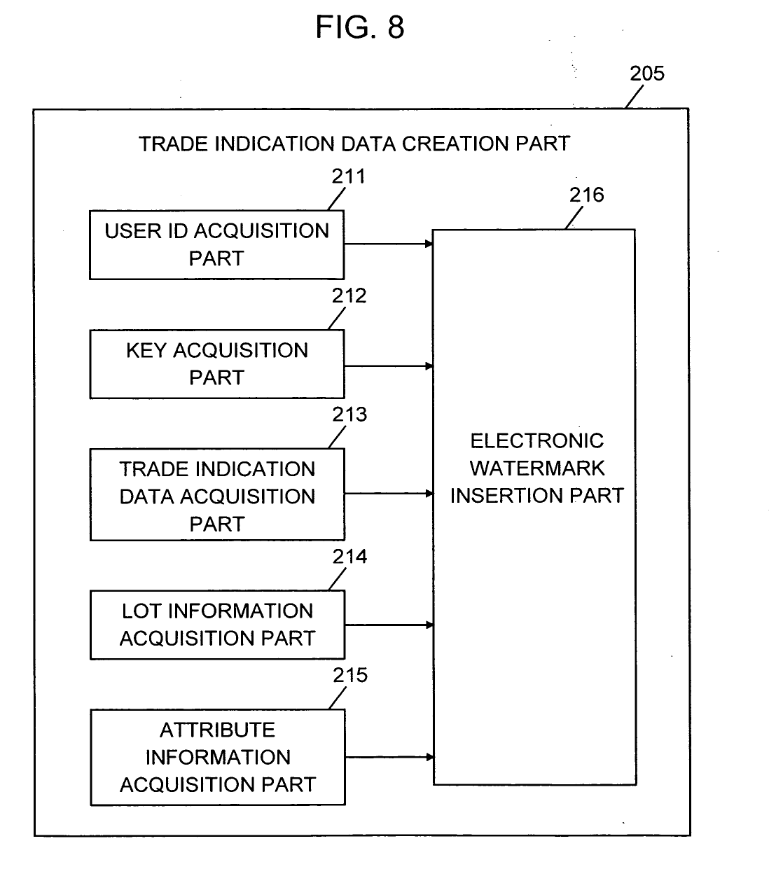

FIG. 8 is a block diagram showing a rough structure of trade indication data creation part 205 shown in FIG. 7. Trade indication data creation part 205 includes user ID acquisition part 211, key acquisition part 212, trade indication data acquisition part 213, lot information acquisition part 214, attribute information acquisition part 215, and electronic watermark insertion part 216. User ID acquisition part 211 acquires a user ID to identify trade indication data reception apparatus 220 and/or user 400. Key acquisition part 212 acquires an electronic watermark key used when the electronic watermark is embedded. Trade indication data acquisition part 213 acquires the trade indication data before the electronic watermark is inserted. Lot information acquisition part 214 acquires lot information of a commodity to which the trade indication is attached. Attribute information acquisition part 215 acquires attribute information such as information related to a limitation on the number of copying or transmission date of the trade indication data.

Storage part 203 stores the user ID, the electronic watermark key, the trade indication data before the electronic watermark is inserted, the lot information and the attribute information. These pieces of information are read from storage part 203 by the respective parts of trade indication data creation part 205. However, with respect to the transmission date of the trade indication data, attribute information acquisition part 215 acquires it from a timer (not shown). Respective trade indication data reception apparatuses 220 and/or users 400 and respective user IDs may be previously made to correspond to each other, or may be made to correspond to each other when transmission is performed. In either case, the correspondence between the user IDs and the trade indication data reception apparatuses and/or the users is stored in storage part 203. As the user ID, the name of the trade indication data reception apparatus may be used as it is. Electronic watermark insertion part 216 inserts the user ID, lot information and attribute information into the trade indication data by using the electronic watermark key.

FIG. 9 is a block diagram showing a rough structure of trade indication data reception apparatus 220 according to the second exemplary embodiment. Trade indication data reception apparatus 220 is connected to storage part 224. Trade indication data reception apparatus 220 includes authentication part 221, reception part 222, and decryption part 223. Authentication part 221 performs an authentication processing in cooperation with authentication part 202 of trade indication data transmission server 200. Reception part 222 receives the trade indication data from trade indication data transmission server 200. Decryption part 223 decrypts the received trade indication data and stores it in storage part 224. Storage part 224 stores a decryption key paired with the encryption key used in encryption part 206 of trade indication data transmission server 200. Decryption part 223 reads this decryption key from storage part 224 and decrypts trade indication data.

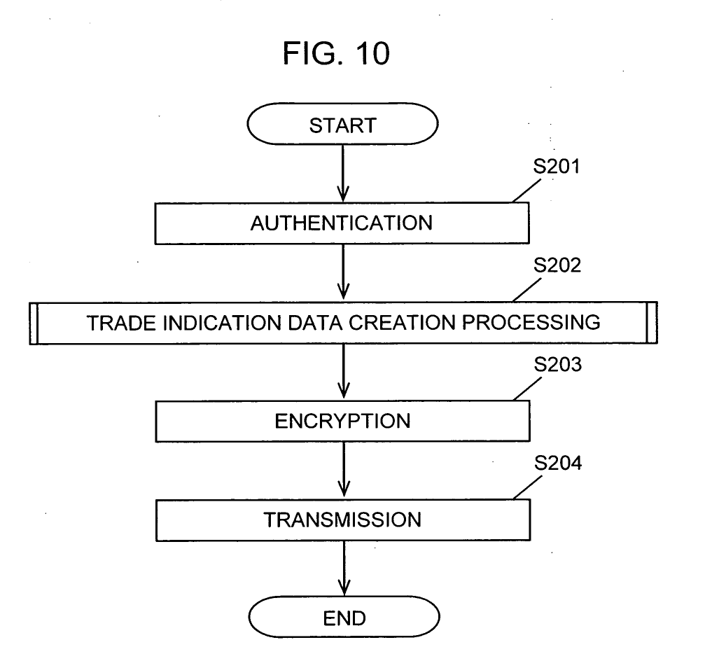

In the above structure, the operation of the second exemplary embodiment will be described with reference to FIGS. 10 to 12. FIG. 10 is a flowchart showing a procedure of trade indication data transmission processing according to the second exemplary embodiment. When trade indication data reception apparatus 220 accesses trade indication data transmission server 200, and a transmission request for the trade indication data is made, or when trade indication data transmission sever 200 accesses trade indication data reception apparatus 220, the trade indication data transmission processing starts.

In the trade indication data transmission processing, first, authentication part 202 performs an authentication processing for authenticating trade indication data reception apparatus 220 (S201). Next, trade indication data creation part 205 inserts an electronic watermark into the trade indication data, and creates the trade indication data corresponding to trade indication data reception apparatus 220 and/or user 400 (S202). Next, encryption part 206 encrypts the created trade indication data (S203). Transmission part 201 transmits the encrypted trade indication data to trade indication data reception apparatus 220 (S204).

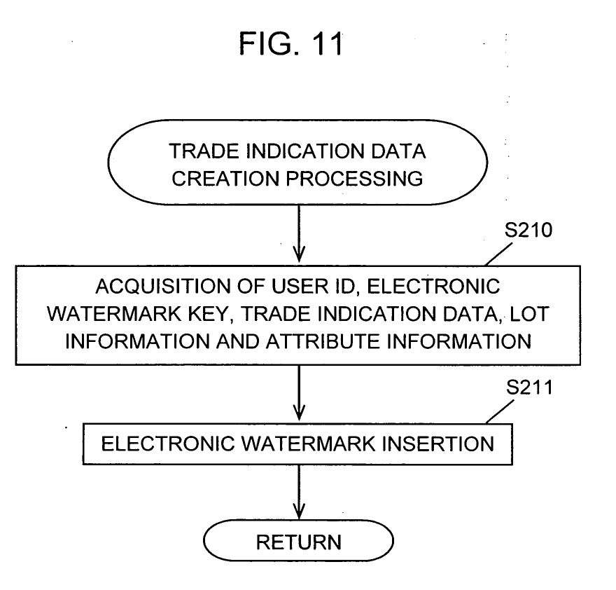

FIG. 11 is a flowchart showing a procedure of trade indication data creation processing according to the second exemplary embodiment. In the trade indication data creation processing of the second exemplary embodiment, trade indication data creation part 205 acquires a user ID, an electronic watermark key, trade indication data, lot information and attribute information (S210), and uses the electronic watermark key to insert the user ID, the lot information and the attribute information into the trade indication data (S211).

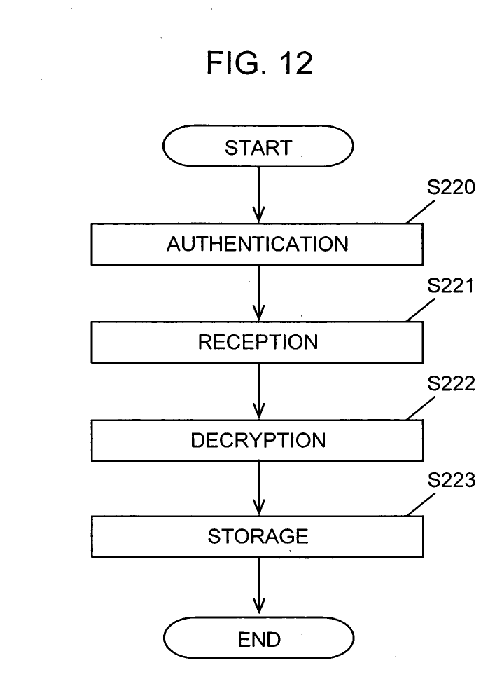

FIG. 12 is a flowchart showing a procedure of trade indication data reception processing according to the second exemplary embodiment. In this trade indication data reception processing, first, authentication part 221 performs an authentication processing in cooperation with trade indication data transmission server 200 (S220). Next, reception part 222 receives the trade indication data transmitted by the foregoing trade indication data transmission processing (S221). Next, decryption part 223 decrypts the received trade indication data (S222). Decryption part 223 stores the decrypted trade indication data into storage part 224 (S223).

As described above, in the second exemplary embodiment, since trade indication data reception apparatus 220 is authenticated, and the trade indication data in which the characteristic corresponding to the authenticated trade indication data reception apparatus 220 and/or user is inserted is transmitted to trade indication data reception apparatus 220, more appropriate transmission of the trade indication data can be made, and further appropriate protection of the trade indication can be made.

### Other Embodiments

Instead of Internet 102 of the foregoing embodiment, another network such as a dedicated line or public line may be used. Trade indication data transmission servers 100 and 200 and trade indication data reception apparatuses 103 and 220 may perform communication by wireless. Storage parts 105, 112, 203 and 224 include, for example, a computer readable recording medium (not shown) such as a hard disk, and store various data into the recording medium. Storage parts 105 and 203 and servers 100 and 200 may be constructed as an integrated unit, or may be constructed of plural units. Similarly, storage parts 112 and 224 and trade indication data reception apparatuses 103 and 220 may be constructed as an integrated unit, or may be constructed of plural units.

Each part of trade indication data transmission servers 100 and 200 and trade indication data reception apparatuses 103 and 220 shown in FIGS. 2, 3, 7, 8 and 9 is embodied in such a manner that for example, a processor (not shown) reads a program stored in a computer readable recording medium (not shown) such as ROM and RAM, and the processor (not shown) executes the program. Alternatively, all of or part of these may be constructed of dedicated hardware. The trade indication data stored in storage parts 112 and 224 is used for, for example, the appearance of trade indication. By using the trade indication data, the trade indication may be physically attached to various products, packaging, advertising, and the like. Namely the trade indication data is displayed on commodities, or the trade indication may be displayed by a display device.

Authentication of trade indication data reception apparatus 103 and/or user 301 may be performed by providing authentication part 202 in trade indication data transmission server 100 of the first exemplary embodiment, and providing authentication part 221 in trade indication data reception apparatus 103. In this case, the authentication processing of trade indication data transmission server 100 is performed before step S101 of FIG. 5, and the authentication processing of trade indication data reception apparatus 103 is performed before step S111 of FIG. 6. Trade indication data creation part 205 may be provided in trade indication data transmission server 100, and the trade indication data corresponding to trade indication data reception apparatus 103 and/or user 301 may be created. In this case, instead of step S101 of FIG. 5, the trade indication data creation processing is performed.

Encryption and decryption of the trade indication data may be performed by providing encryption part 206 in trade indication data transmission server 100, and providing decryption part 223 in trade indication data reception apparatus 103. In this case, the encryption processing is performed before step S102 of FIG. 5, and the decryption processing is performed after step S111 of FIG. 6. A trade indication data creation part for creating the trade indication data corresponding to trade indication data reception apparatus 103 by inserting a characteristic corresponding to trade indication data reception apparatus 103 and/or user 301 into the trade indication data may be provided in trade indication data transmission server 100. In this case, instead of step S101 of FIG. 5, a characteristic insertion processing is performed.

The trade indication data creation part inserts the characteristic as shown in FIGS. 4A-4E into the trade indication data. In this case, storage part 105 stores the characteristics corresponding to trade indication data reception apparatuses 103, and trade indication data before the insertion of the characteristic. The trade indication data creation part reads the characteristic corresponding to trade indication data reception apparatus 103 and/or user 301, and the trade indication data before the insertion of the characteristic from storage part 105, and inserts the characteristic into the read trade indication data. Transmission part 104 may transmit the trade indication data in which the characteristic is modified for each lot.

Key acquisition part 212 of the second exemplary embodiment may be omitted, and the electronic watermark may be inserted without using an electronic watermark key. In this case, even if there is no electronic watermark key, information of electronic watermark can be extracted from the trade indication data. Lot information acquisition part 214 may be omitted, and insertion of lot information may be omitted. Attribute information acquisition part 215 may be omitted, and insertion of attribute information may be omitted. Reception part 222 may store received trade indication data into storage part 224 without decrypting it. In this case, decryption is performed when the trade indication data is used.

In the foregoing embodiments, although the example in which the trade indication data is transmitted is described, instead of transmission of the trade indication data, a paper indicating the trade indication data may be delivered to the user, or the recording medium such as the optical disk storing the trade indication data may be delivered to the user. In the foregoing embodiment, although the trade indication data is transmitted by using the network, the trade indication data may be directly transmitted from the trade indication data transmission server to the trade indication data reception apparatus without the network. In the case where the provider and the user use the same apparatus, the attribute of the trade indication data may be switched from the provider to the user in the apparatus.

As described above, according to the present invention, since a characteristic to identify the user to use the data is inserted in the trade indication data, when the trade indication data is falsely used, the origin of the trade indication data can be identified, and therefore, the trade indication can be appropriately protected.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claim is:

1. A data medium carrying instructions readable by a processing apparatus to perform the step of:
generating a trademark having a user characteristic indication which identifies a user authorized to use the trademark,
wherein the user characteristic indication varies according to a user of the trademark.

2. The data medium of claim 1, wherein the data medium comprises at least one of: a storage medium and a transmission medium.

3. The data medium of claim 1, wherein the user characteristic indication includes at least one of: a change in an angle of a swept line of a character, a change in the penetration of a character, a shift of a part of the trademark horizontally or vertically, a rotation of a part of the trademark, a change in color of part of the trademark, use of or a change in a hologram in the trademark, and use of or a change in a three-dimensional view in the trademark.

4. A trademark data transmission method comprising:
a step of preparing a trademark data in which a user characteristic indication is inserted; and
a step of transmitting the trademark data associated with the user characteristic indication;
wherein the user characteristic indication varies according to a user of the trademark data.

5. A trade indication data transmission method comprising:
an authentication step of authenticating at least one of a reception apparatus to receive trade indication data and a user to use the received trade indication data; and
a transmission step of transmitting the trade indication data in which a characteristic indication corresponding to at least one of the reception apparatus and the user authenticated at the authentication step is inserted to the user.

6. A trade indication data transmission method according to claim 5, further comprising a step of modifying the user characteristic indication for each lot of a commodity.

7. A trade indication data transmission method according to claim 5, wherein the user characteristic indication is inserted in a display pattern of the trade indication, and
the user characteristic indication is recognizable from appearance of the trade indication.

8. A trade indication data transmission method according to claim 5, wherein the user characteristic indication is an electronic watermark.

9. A trade indication data transmission method according to claim 5, wherein the user characteristic indication further comprising information to limit a number of duplicating the trade indication data.

10. A trade indication data transmission method according to claim 5, wherein; a trade indication data and a user characteristic indication inserted in the trade indication data are attached at a commodity; and
the user characteristic indication varies according to a user of the trade indication data.

11. A trade indication data transmission method according to claim 5, wherein;
the trade indication is one selected from a group consisting of an indication of business, a name related to business of a person, a trade name, a trademark, an emblem, a container of a commodity and a packaging of a commodity.

12. A trade indication data transmission server comprising:
a processor which prepares trade indication data in which a user characteristic indication inserted; and
a transmitter which transmits the trade indication data associated with the user characteristic indication;
wherein the user characteristic indication varies according to a user of the trade indication data.

13. A trade indication data transmission server, comprising:
an authentication unit which authenticates at least one of a reception apparatus to receive trade indication data and a user to use the received trade indication data; and
a transmission unit for transmitting the trade indication data in which a characteristic corresponding to at least one of the reception apparatus and the user authenticated by the authentication unit is inserted to the transmission destination.

14. A trade indication data receiver which performs an authentication of the receiver and/or a user in cooperation with a trade indication data transmission server for transmitting trade indication data, the trade indication data receiver comprising:
an authentication unit which performs an authentication of the receiver and/or a user of the trade indication data; wherein the receiver and/or the user has an authority to use the trade indication data;
a reception unit which receives the trade indication data and a user characteristic indication inserted in the trade indication data; wherein the user characteristic indication is varied for each receiver and/or user.

15. A trade indication data transmission system comprising:
a trade indication data transmission server for transmitting trade indication data; and
plural trade indication data reception apparatuses for receiving the trade indication data,
wherein the trade indication data transmission server comprises:
a server side authentication unit which authenticates at least one of a reception apparatus to receive trade indication data and a user to use the received trade indication data; and
a transmission unit for transmitting the trade indication data in which a characteristic corresponding to at least one of the reception apparatus and the user authenticated by the authentication unit is inserted to the transmission destination; and,
wherein the trade indication data reception apparatus comprises:
a reception side authentication unit which performs an authentication of the receiver and/or a user of the trade indication data; wherein the receiver and/or the user has an authority to use the trade indication data;
a reception unit which receives the trade indication data and a user characteristic indication inserted in the trade indication data; wherein the user characteristic indication is varied for each receiver and/or user.

16. A data medium carrying instructions readable by a processing apparatus to perform the step of:
generating a trade indication having a user characteristic indication which identifies a user authorized to use the trade indication,
wherein the user characteristic indication varies according to a user of the trade indication.

17. The data medium of claim 16, wherein the data medium comprises at least one of: a storage medium and a transmission medium.

18. The data medium of claim 16, wherein the user characteristic indication includes at least one of: a change in an angle of a swept line of a character, a change in the penetration of a character, a shift of a part of the trade indication horizontally or vertically, a rotation of a part of the trade indication, a change in color of part of the trade indication, use of or a change in a hologram in the trade indication, and use of or a change in a three-dimensional view in the trade indication

19. A trade indication data transmission method comprising:
a step of preparing a trade indication data in which a user characteristic indication is inserted; and
a step of transmitting the trade indication data associated with the user characteristic indication;
wherein the user characteristic indication varies according to a user of the trade indication data.

20. A trade indication data transmission method according to claim 19, further comprising a step of modifying the user characteristic indication for each lot of a commodity.

21. A trade indication data transmission method according to claim 19, wherein the user characteristic indication is inserted in a display pattern of the trade indication, and
the user characteristic indication is recognizable from appearance of the trade indication.

22. A trade indication data transmission method according to claim 19, wherein the user characteristic indication is an electronic watermark.

23. A trade indication data transmission method according to claim 19, wherein the user characteristic indication further comprising information to limit a number of duplicating the trade indication data.

24. Trade indication data recorded on a recording medium which is readable by an information processing apparatus, comprising:
a user characteristic indication inserted in the trade indication data;
wherein the user characteristic indication varies according to a user of the trade indication data.

25. A commodity on which trade indication data is displayed, wherein
the trade indication data includes a user characteristic indication which varies according to a user of the trade indication data.
